(19) United States
(12) Patent Application Publication
(10) Pub. No.: US 2011/0292319 A1
(43) Pub. Date: Dec. 1, 2011

(54) DUAL MODE ELECTRO-OPTIC DISPLAYS

(75) Inventor: David John Cole, Medway, MA (US)

(73) Assignee: E INK CORPORATION, Cambridge, MA (US)

(21) Appl. No.: 13/116,081

(22) Filed: May 26, 2011

Related U.S. Application Data
(60) Provisional application No. 61/348,781, filed on May 27, 2010.

(51) Int. Cl. G02F 1/1335

(52) U.S. Cl. 349/62

(57) ABSTRACT

A display comprises, in this order: a layer (104) of an electro-optic medium switchable between transmissive and non-transmissive optical states; a shutter means (130) switchable between reflective and transmissive optical states; and a light source (102). The display can operate in either a reflective mode or a transmissive mode, and the whole area of the display functions in both modes.

### REFERENCE TO RELATED APPLICATION

This application claims benefit of Provisional Application Ser. No. 61/348,781, filed May 27, 2010.

### BACKGROUND OF INVENTION

This invention relates to dual mode electro-optic displays. These dual mode displays are designed to be viewable over a wide range of lighting conditions.

The term “electro-optic”, as applied to a material or a display, is used herein in its conventional meaning in the imaging art to refer to a material having first and second display states differing in at least one optical property, the material being changed from its first to its second display state by application of an electric field to the material. Although the optical property is typically color perceptible to the human eye, it may be another optical property, such as optical transmission, reflectance, luminescence or, in the case of displays intended for machine reading, pseudo-color in the sense of a change in reflectance of electromagnetic wavelengths outside the visible range.

Electro-optic displays can be divided into two main types depending upon whether the electro-optic medium is transmissive or reflective. Transmissive electro-optic media, such as the liquid crystals used in most conventional liquid crystal displays in laptop computers, flat panel televisions etc., form an image by varying the proportion of light incident upon one surface of the layer of electro-optic medium to pass through the medium and emerge from the opposed surface. Such media are typically used with a backlight disposed on the opposed side of the electro-optic medium from the viewing surface of the display. On the other hand, reflective electro-optic media, such as the electrophoretic media commonly used in electronic book readers, form an image by varying the proportion of light incident upon the viewing surface of the layer of electro-optic medium which is reflected back from the electro-optic medium and emerges through the same viewing surface of the display. A transmissive electro-optic medium can be used to form a “pseudo-reflective” display by positioning a reflector on the opposed side of the electro-optic medium from the viewing surface of the display so that light entering through the viewing surface passes a first time through the electro-optic medium, is reflected from the reflector, passes a second time through the electro-optic medium, and re-emerges from the viewing surface of the display; commercial cholesteric liquid crystal displays are of this type.

Transmissive and reflective electro-optic displays have complementary advantages and disadvantages. Transmissive displays tend to have high power consumption because the backlight consumes a substantial fraction of the power required by the display. Furthermore, transmissive displays are difficult or impossible to read in bright sunlight or other high illumination conditions, because the amount of light which emerges from the viewing surface of the display is limited by the power of the backlight, and in practice in bright sunlight the light emerging from the viewing surface tends to be swamped by the inevitable reflections of the sunlight from the viewing surface. In this connection, it should be noted that commercial liquid crystal media, even in their supposedly “transparent” state, typically only transmit about 5 percent of the light from the backlight, when allowance is made for the light absorbed by the necessary polarizers, rubbing layers etc. Finally, many people find that attempting to read on a transmissive display for long periods leads to eyestrain due to glare from the transmissive media.

Transmissive displays are, however, often preferred for use in displaying color images indoors. Most commercial electro-optic media are essentially monochrome, i.e., in transmissive media, the medium itself displays only, non-transmissive (black) and transmissive (white) optical states, and typically a number of intermediate gray states. To produce a color image, it is necessary to have the light which will form the image pass through not only the electro-optic medium but also a color filter array having a number of sections having different colors, typically red, green and blue, or red, green, blue and white. Thus, if a red/green/blue color filter array is used, and a portion of the display is to display a solid red image, the sub-pixels of the electro-optic medium adjacent the red areas of the color filter array are set to their transmissive state, while the sub-pixels of the electro-optic medium adjacent the green and blue areas of the color filter array are set to their non-transmissive state. Accordingly, red light in fact emerges from only one-third of the area of the display. However, if the sub-pixels are made sufficiently small, and the backlight sufficiently bright, an observer will still perceive a bright, well saturated red from the relevant portion of the display. In addition, of course, transmissive displays are viewable in conditions of complete darkness.

Reflective displays do not require backlights and thus typically have lower power requirements than transmissive displays. Furthermore since, for any specific image displayed, a reflective display reflects back to the observer a fixed fraction of the light incident on its viewing surface, the apparent brightness of the image adjusts automatically to changes in ambient lighting, and the display is readily readable even in the brightest sunlight. However, reflective displays do not typically produce bright color images; for the reasons discussed above with regard to transmissive displays, if a reflective display is used with a red/green/blue color filter array and it is desired to display an area of solid red, red light is reflected from only one-third of this area, and in a reflective display it is not possible to use a bright backlight to increase the amount of red light emerging from this one-third of the area. Finally, if a reflective display is to viewed in darkness or under very low light conditions, it is necessary to provide a front light for the display.

Pseudo-reflective displays produced by positioning a reflector on the opposed side of the electro-optic medium from the viewing surface of the display tend to suffer from poor contrast ratios since a large proportion of the light incident upon the viewing surface is typically absorbed in the double transit of the electro-optic medium and only a small fraction re-emerges from the viewing surface to form the desired image.

The foregoing advantages and disadvantages of transmissive, reflective and pseudo-reflective displays are well known to anyone skilled in the technology of electro-optic displays, and for obvious reasons attempts have been made to combine transmissive and reflective displays in a manner which combines the advantages of both types of displays. One interesting proposal along these lines is found in International Application No. WO 2008/063171 by One Laptop per Child Association, Inc.; FIG. 1 of this International Application is reproduced as FIG. 1 of the present application. Essentially, this International Application describes a liquid crystal display in which part of each sub-pixel has a reflective backplane and the remainder of each sub-pixel has a transmissive backplane, through which light from a backlight can pass to rear light the sub-pixel in the same way as in a conventional transmissive liquid crystal display. As described in the International Application, FIG. 1 is a schematic cross-section of one sub-pixel (generally designated 100) of the display. The sub-pixel 100 comprises a liquid crystal material 104, a sub-pixel electrode 106, a common electrode 108, a reflective area 110, a transmissive area 112, substrates 114 and 116, spacers 118a and 118b, a first polarizer 120, and a second polarizer 122. A light source (backlight) 102 or ambient light 124 illuminates pixel 100. Liquid crystal material 104 rotates the axis of the polarization of the light from light source 102 or ambient light 124 dependent upon the potential difference applied between pixel electrode 106 and common electrode 108. Reflective area 110 is electrically conductive and reflects ambient light 124 to illuminate pixel 100. Reflective area 110 is made of metal and is electrically coupled to pixel electrode 106 thereby, providing the potential difference between reflective area 110 and common electrode 108. Transmissive area 112 transmits light from light source 102 to illuminate pixel 100. Substrates 114 and 116 enclose liquid crystal material 104, pixel electrode 106 and common electrode 108. A driver circuit 130 sends signals related to pixel values to switching elements. Spacers 118a and 118b are placed over reflective part 110 to maintain a uniform distance between substrates 114 and 116.

This display uses permanent transmissive 112 and reflective 110 areas in each sub-pixel of the backplane. In the (full color) backlit (transmissive) mode, light from the backlight 102 passes through the rear polarizer 120, the rear substrate 114, the pixel electrode 106, the transmissive area 112, the liquid crystal 104, the common front electrode 108, the front substrate 116 and the front polarizer 122. (The transmissive area 112 of each pixel is colored red, green or blue to produce a corresponding color in the color of the light transmitted therethrough.) In the (monochrome gray scale) reflective mode, ambient light 124 entering the viewing surface of the display passes through the front polarizer 122, the front substrate 116, the front electrode 108 and the liquid crystal 104). The light is then reflected from the reflective area 110 and passes back through the same layers to emerge from the front polarizer 122 to provide a reflective display.

Note that the reflective areas 110 are “elevated above” (i.e., moved to the right in FIG. 1) the transmissive areas 112 so that the thickness of the liquid crystal between the front electrode 108 and the reflective areas 110 is only one-half of the thickness of the liquid crystal between the front electrode 108 and the transmissive areas 112, thus automatically allowing for the double passage of the light through the liquid crystal in the reflective mode as compared with the single passage in the transmissive mode.

The fundamental problem with this system is that, like all compromises, it does not perform especially well in either mode. The division of each sub-pixel of the display into permanent reflective and transmissive areas necessarily compromises the brightness of the display in both modes, and results in the need for a complicated custom backplane which involves increased expense. Furthermore, the International Application itself admits (see paragraph bridging pages 5 and 6 thereof) that the relative placement of the reflective and transmissive areas needs to be chosen carefully since improper placement can produce visible effects in the image.

As described in the International Application, the reflective mode of the display is monochromatic gray scale, because either a rear color filter is used covering the transmissive areas 112 or the backlight 102 is itself colored.

The “elevation” of the reflective areas 110 above the transmissive areas 112 to adjust for double passage of light through the liquid crystal appears problematic. Given the thin layers of liquid crystal typically used in commercial displays, maintaining the 2:1 ratio between the different areas of the liquid crystal is a considerable engineering challenge; the International Application suggests that spacers 118a, 118b be provided between the reflective areas 110 and the front electrode 108 but does not describe the exact form of such spacers or how they are to be formed in a mass-produced display. (The form of the spacers shown in FIG. 1 is apparently purely schematic, given that the entire sub-pixel should be no more than about 0.2 mm across for an acceptable color display.) A more serious problem is whether the reflective areas 110 should be conductive or non-conductive. As mentioned above, the International Application teaches that the reflective areas are formed of metal and are conductive, so that the reflective areas stay at the same potential as the rear electrode 106. This, however, would result in an electric field between the reflective areas and the front electrode which is (to a first approximation) twice the electric field between the transmissive areas and the front electrode, which is not apparently what is needed for proper functioning of the display. Also, such an arrangement would result in a highly non-uniform electric field within the pixel, which would appear to compromise achieving accurate gray scale. If, on the other hand, the reflective areas were made non-conductive, or at least electrically isolated from the pixel electrode, there would still be a problem with non-uniform electric fields, since it would be difficult to make the material between the pixel electrode and the reflective areas have exactly the same dielectric constant as the liquid crystal overlying the transmissive areas.

Incidentally, it is not clear from the International Application whether the display always functions simultaneously in both reflective and transmissive modes, but if so leaving the backlight on in bright sunlight, where the transmissive mode is virtually useless, is a major waste of energy.

It has now been realized that the efficiency of the display shown in FIG. 1, and similar displays, could be substantially increased by avoiding the division of the backplane into permanent reflective and transmissive areas, and instead provide a “switching means”, switchable between reflective and transmissive modes, on the opposed side of the liquid crystal (or similar transmissive electro-optic medium) from the viewing surface of the display.

### SUMMARY OF INVENTION

Accordingly, this invention provides a display comprising, in this order:
a layer of an electro-optic medium switchable between transmissive and non-transmissive optical states;
a shutter means switchable between reflective and transmissive optical states; and
a light source.

The electro-optic medium used in the display of the present invention may be a liquid crystal. The shutter means may be, for example, a mechanical shutter; such a shutter could have a plurality of vanes which can be rotated between a closed position in which they lie parallel to the plane of the layer of electro-optic medium and present a reflective surface towards the layer of electro-optic medium, and an open position, in which they lie perpendicular to the plane of the layer of electro-optic medium and allow light from the light source (backlight) to reach the layer of electro-optic medium. However, in general it is preferred that the shutter means be a layer of electro-optic material capable of being switched between a reflective state and a transmissive optical state. Such an electro-optic material may be of the type described in U.S. Pat. No. 7,312,916; this medium comprises flat metal flakes dispersed in a fluid and movable between a reflective state, in which the flakes lie flat against one surface of the material, and a transmissive state, in which the flakes lie substantially perpendicular to this surface, thus allowing light to pass through the electro-optic material. However, any type of electro-optic material switchable between a transmissive and a reflective state may be used, and it should be noted that the reflective state need not be specularly reflective; substantially Lambertian (scattering) reflectivity will suffice. Numerous types of “light gates” are described in the literature, and many of these provide, or can be modified to provide, a reflective state. For example, several types of electrophoretic media are known having one (reflective/non-transmissive) optical state in which the electrophoretic particles occupy substantially the entire area of the medium and a second (transmissive) optical state in which the particles occupy only a minor part of the area of the medium; see, for example, U.S. Pat. Nos. 7,327,511; 5,728,251; 5,650,872; and 5,463,492. By choosing particles which will form a reflective surface in the non-transmissive optical state, such media may readily be adapted for use in the present invention.

Although, in the display of the present invention, the shutter means is disposed between the layer of electro-optic medium and the light source or backlight, depending upon the exact type of electro-optic medium employed, it may be necessary or desirable to dispose certain auxiliary layers needed for proper functioning of the electro-optic medium on the opposed side of the shutter means in order to allow optimum functioning of the display in its reflective mode (as described below). In particular, where the electro-optic medium is a liquid crystal medium which requires electrodes and polarizers on both sides of the liquid crystal medium (cf. FIG. 1), the rear polarizer of the liquid crystal medium may be disposed between the shutter means and the backlight, i.e., the shutter means may be disposed between the rear electrode and rear polarizer of the display. This placement avoids light having to pass (twice) through the rear polarizer when the display is operating in its reflective mode. More generally, when determining the optimum structure for a display of the present invention, consideration should always be given to avoiding unnecessary passage of light through light-absorbing layers when the display is operating in its reflective mode.

The display of the present invention may further comprise a light sensor arranged to sense ambient light level, the light sensor being arranged to place the shutter means in its transmissive optical state and the activate the light source when the ambient light level falls below a predetermined value. Also, in the present display, the light source may be arranged to be switched off when the shutter means is in its reflective mode. For reasons described below, the display of the present invention may further comprise a rear color filter disposed between the light source and the layer of electro-optic medium, and may also comprise a front color filter disposed on the opposed side of the layer of electro-optic medium from the rear color filter.

Finally, this invention provides a method of operating a display of the present invention. This method comprises placing the shutter means in its reflective optical state, turning off the light source, and placing a first image on the electro-optic medium; and placing the shutter means in its transmissive optical state, turning on the light source and placing a second image on the electro-optic medium.

### BRIEF DESCRIPTION OF DRAWINGS

As already mentioned, FIG. 1 of the accompanying drawings is a schematic cross-section through of one sub-pixel of the prior art display described in International Application No. WO 2008/063171.

FIG. 2 is a schematic cross-section, similar to that of FIG. 1, through one sub-pixel of a display of the present invention which may be regarded as a modification of the prior art display of FIG. 1.

### DETAILED DESCRIPTION

As indicated above, the present invention provides a display comprising a layer of an electro-optic medium switchable between transmissive and non-transmissive optical states; a shutter means switchable between reflective and transmissive optical states; and a light source. The presence of the switching means in such a display enables the whole area of each sub-pixel of the display to operate in either a reflective mode or a transmissive mode. This enhances the efficiency of the display in both modes and avoids any problems (such as optical artifacts) which may be caused by the presence of separate transmissive and reflective areas in each sub-pixel.

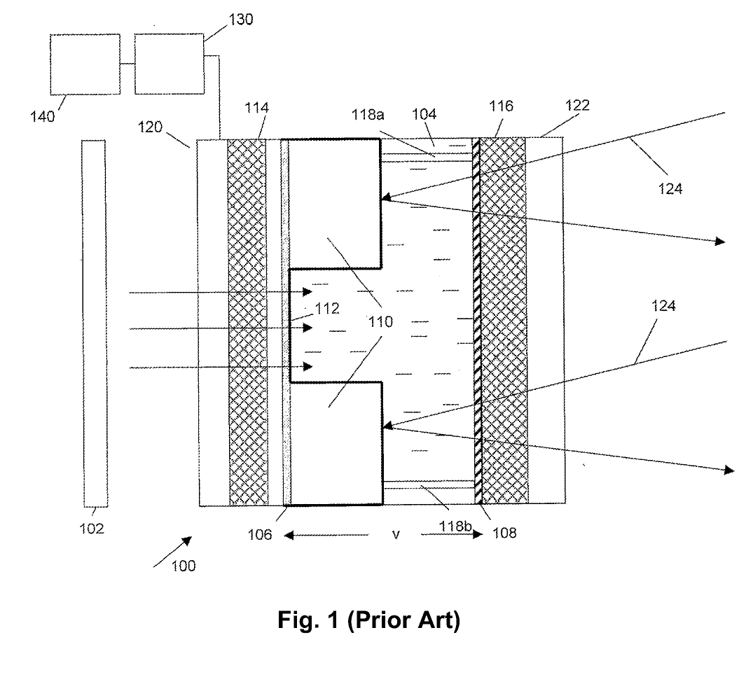

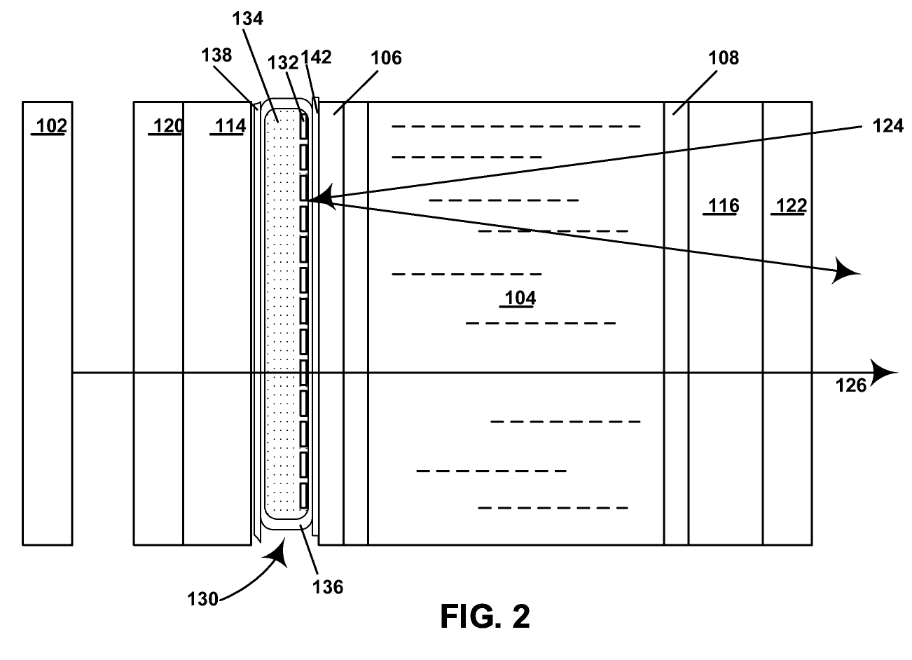

FIG. 2 illustrates a display of the present invention which may be regarded as a modification of the prior art display of FIG. 1. In the display of FIG. 2, the second polarizer 122, the front substrate 116, the common electrode 108, the liquid crystal 104, the sub-pixel electrode 106, the rear substrate 114, the first polarizer 120 and the backlight 102 are all essentially identical to the corresponding integers in the display of FIG. 1. However, the elevated areas 110 in FIG. 1 are eliminated so that the surface over sub sub-pixel electrode 106 is planar. An encapsulated metal flake medium (generally designated 130) is interposed between the sub-pixel electrode 106 and the rear substrate 114. The medium 130 comprises flat metal flakes 132 in a fluid 134 encapsulated in capsules 136, and disposed between electrodes 138 and 140; this medium 130 essentially operates in a shutter mode. In the reflective state of the medium 130 (as illustrated in FIG. 2) the metal flakes 132 form a flat reflective sheet adjacent the electrode 140, thus forming a reflective surface. In the transmissive state of the medium 130, the metal flakes 132 are turned perpendicular to the electrodes 138 and 140, thus allowing light from the backlight 102 to pass through the rear electrode 106.

The transmissive state of the medium may be achieved by dielectrophoretic driving of the medium; since flat metal flakes are highly polarizable, they will readily respond to dielectrophoretic driving, and relatively slow dielectrophoretic driving is not objectionable for this purpose, since such driving is only required when the display is being switched between reflective and transmissive modes of operation (as discussed in detail below), and anyone switching between reflective and transmissive modes on taking a display outdoors or into a brightly lit space would need to pause for a few seconds to allow his eyes to adjust to the changed lighting conditions. (Although dielectrophoretic driving tends to be energy intensive, it would only need to applied on switching between reflective and transmissive modes, or for refreshing the medium 130 at infrequent intervals, so the energy required for such driving is not great.) Alternatively and perhaps more simply, the metal flakes could simply be driven using a short pulse of a driving voltage between the electrodes 138 and 140, whereupon viscous forces will cause the flakes to orient edge-on to the electrodes.

As already noted, in the display of FIG. 2 the elevated reflective areas 110 present in the display of FIG. 1 are eliminated, thus avoiding the problems of non-uniform electric fields discussed above, and the problems associated with correct placement of these reflective areas also discussed above. In essence, the liquid crystal portion of the display is now a conventional active matrix liquid crystal display with a standard backplane, and capable of using conventional spacers if desired.

It should be noted that since, as explained below, the whole display operates at any one moment in either a reflective or transmission mode, the metal flake medium 130 will operate as a single pixel with both its electrodes 138 and 140 being common electrodes extending across the whole display, thus permitting a very simple control circuit for this medium.

The modes of operation of the display of FIG. 2 will readily be apparent. In the transmissive mode of the display, the metal flakes are arranged perpendicular to the electrodes 138 and 140 and the display functions in a manner exactly parallel to the transmissive mode of the display of FIG. 1, except that the whole area of the sub-pixel operates in transmissive mode. Thus, in this mode, light 126 emitted from backlight 102 passes through the rear polarizer 120, the rear substrate 114, the metal flake medium 130, the rear electrode 106, the liquid crystal medium 104, the front electrode 108, the front substrate 116 and the front polarizer 122, and emerges from the viewing surface (the right-hand surface of front polarizer 122, as illustrated in FIG. 2). In contrast, in the reflective mode of the display, the metal flakes 132 in effect form a mirror adjacent the rear electrode 106, and light 124 entering the display through the front surface passes through the front polarizer 122, the front substrate 116, the front electrode 108, the liquid crystal 104, and the rear electrode 106. The light 124 is then reflected from this mirror formed by the metal flakes 132 (instead of from the elevated reflective areas 110 shown in FIG. 1), and passes back through the rear electrode 106, the liquid crystal medium 104, the front electrode 108, the front substrate 116 and the front polarizer 122, and emerges from the viewing surface. Thus, the reflective mode of the display of FIG. 2 is similar to the reflective mode of the display of FIG. 1, except that the whole area of the sub-pixel operates in reflective mode.

The double passage of the light 124 through the full thickness of the liquid crystal in the reflective mode of the display of FIG. 2 will cause the path length of the light through the liquid crystal in the reflective mode to be twice the path length in the transmissive mode, so that, depending upon the relative directions of the front 122 and rear 120 polarizers, it may be necessary to change operating voltage between the two modes; the necessary changes are well within the skill of people familiar with liquid crystal displays. Indeed, to the extent that the greater path length through the liquid crystal may tend to require reduction of operating voltage to achieve the same rotation of the plane of polarization over a doubled path length, such reduction of operating voltage in the reflective mode may be an advantage in that the reduction of operating voltage will cause a reduction in power consumption, which is desirable in as much as the reflective mode will typically be used outdoors or when travelling, and thus in circumstances where the display may be required to operate on batteries for extended periods.

Unlike the prior art display shown in FIG. 1, the display of FIG. 2 operates either in reflective or in transmissive mode at any given time. Thus, provision must be made for switching between the two modes. Such switching could be effected by means of a dedicated switch on the display or other part of the apparatus, or effected via software on an accompanying keyboard, perhaps using a hot key. Alternatively, switching could be effected by providing a light sensor on the display or other part of the apparatus, and switching to reflective mode when the light level exceeds a predetermined value. Regardless of the exact switching method used, the backlight should preferably be switched off when the display is in reflective mode, where the backlight is useless and wastes energy.

The display shown in FIG. 2 can be modified to provide color in both reflective and transmissive modes, although this does require two separate color filters. A front color filter is provided (for example as part of the front substrate 116) having sufficient saturation to provide desired color when the display is in reflective mode (i.e., when the light is making a double pass through the filter). To provide sufficient color saturation when the display is in transmissive mode, a second color filter is provided between the metal flake medium 130 and the backlight 102, or the backlight itself is colored, in the same way as in the prior art display, so that proper color is achieved when the light from the backlight undergoes a single pass through both color filters on its way to an observer. There is no absolute requirement that the two color filters have the same degree of saturation; if some color shift between the reflective and transmissive modes can be tolerated (and apparently human color perception does shift with ambient light level), it may be desirable to desaturate the front color filter to provide greater reflectivity in the reflective mode, with a corresponding increase in the saturation of the rear color filter.

From the foregoing, it will be seen that the display of the present invention shown in FIG. 2 provides several scan provides several substantial advantages over the prior art display shown in FIG. 1. The display of the present invention provides increased brightness in both its reflective and its transmissive modes, since the whole area of each sub-pixel is used effectively in both modes. The present display also allows color to be provided in both reflective and transmissive modes, and allows for reduction in cost by elimination of a non-standard backplane. The present display also provides improved optical performance due to (i) elimination of optical effects caused by contrast between reflective and transmissive area of backplane; and (ii) elimination of non-uniform electric fields within the liquid crystal.

It will be apparent to those skilled in the art that numerous changes and modifications can be made in the specific embodiments of the invention described above without departing from the scope of the invention. Accordingly, the whole of the foregoing description is to be interpreted in an illustrative and not in a limitative sense.

1. A display comprising, in this order:
a layer of an electro-optic medium switchable between transmissive and non-transmissive optical states;
a shutter means switchable between reflective and transmissive optical states; and
a light source.

2. A display according to claim 1 in which the electro-optic medium is a liquid crystal.

3. A display according to claim 1 in which the shutter means comprises a mechanical shutter.

4. A display according to claim 1 in which the shutter means comprises a layer of electro-optic material capable of being switched between a reflective state and a transmissive state.

5. A display according to claim 4 in which the electro-optic material forming the shutter means comprises flat metal flakes dispersed in a fluid and movable between a reflective state, in which the flakes lie flat against one surface of the material, and a transmissive state, in which the flakes lie substantially perpendicular to this surface, thus allowing light to pass through the electro-optic material.

6. A display according to claim 4 in which the electro-optic material forming the shutter means comprises an electrophoretic medium having a reflective optical state in which the electrophoretic particles occupy substantially the entire area of the medium and a transmissive optical state in which the particles occupy only a minor part of the area of the medium.

7. A display according to claim 2 in which the liquid crystal medium is provided with polarizers on both sides of the liquid crystal medium, and wherein one polarizer is disposed between the shutter means and the light source.

8. A display according to claim 1 further comprising a light sensor arranged to sense ambient light level, the light sensor being arranged to place the shutter means in its transmissive optical state and the activate the light source when the ambient light level falls below a predetermined value.

9. A display according to claim 1 in which the light source is arranged to be switched off when the shutter means is in its reflective mode.

10. A display according to claim 1 further comprising a rear color filter disposed between the light source and the layer of electro-optic medium.

11. A display according to claim 10 further comprising a front color filter disposed on the opposed side of the layer of electro-optic medium from the rear color filter.

12. A method of operating a display, the display comprising a layer of an electro-optic medium switchable between transmissive and non-transmissive optical states; a shutter means switchable between reflective and transmissive optical states; and a light source,
the method comprising:
placing the shutter means in its reflective optical state, turning off the light source, and placing a first image on the electro-optic medium; and
placing the shutter means in its transmissive optical state, turning on the light source and placing a second image on the electro-optic medium.
